(19) United States
(12) Patent Application Publication
(10) Pub. No.: US 2016/0124264 A1
(43) Pub. Date: May 5, 2016

(54) COMPENSATION STRUCTURE FOR LIQUID CRYSTAL PANELS AND THE LIQUID CRYSTAL DISPLAYS

(71) Applicant: Shenzhen China Star Optoelectronics Technology Co. Ltd., Shenzhen, Guangdong (CN)

(72) Inventors: Bo HAI, Shenzhen, Guangdong (CN); Chih-tsung KANG, Shenzhen, Guangdong (CN)

(73) Assignee: Shenzhen China Star Optoelectronics Technology Co. Ltd., Shenzhen, Guangdong (CN)

(21) Appl. No.: 14/399,944

(22) PCT Filed: Nov. 5, 2014
(86) PCT No.: PCT/CN2014/090332

§ 371 Date: Nov. 7, 2014

(51) Int. Cl. G02F 1/1335; G02F 1/13363

(52) U.S. Cl. CPC G02F 1/133528; G02F 1/13363

(57) ABSTRACT

A compensation structure of liquid crystal panels is disclosed. The compensation structure includes a liquid crystal panel and a first polarizing film and a second polarizing film arranged on two opposite surfaces of the liquid crystal panel. The liquid crystal panel comprises a liquid crystal layer having a plurality of liquid crystal molecules. An anisotropy reflective index of the liquid crystal layer is Δn, the thickness of the liquid crystal layer is d, and a pretilt angle of the liquid crystal molecules is θ. The first compensation film is a biaxial compensation film, and an in-plane retardation value and a thickness retardation value of the first compensation film are respectively Ro1 and Rth1. The second compensation film is the single-axial compensation film, and the thickness retardation value of the second compensation film is Rth2, wherein: 324.3 nm≦Δn×d≦342.7 nm; 85°≦θ<90°; 55 nm≦Ro1≦78 nm; 208 nm≦Rth1≦293 nm; Y1 nm≦Rth2≦Y2 nm; Y1=0.001897×(Rth1)²−2.01×Rth1+438.7; and Y2=−0.005756×(Rth1)²+1.654×Rth1+55.7. In addition, a liquid crystal device including the above compensation structure is also disclosed.

### BACKGROUND OF THE INVENTION

1. Field of the Invention

The present disclosure relates to liquid crystal display technology, and more particularly to a compensation structure for liquid crystal panels and the liquid crystal display (LCD) with the same.

2. Discussion of the Related Art

LCDs are flat and thin display devices including a plurality of colorful or black pixels arranged in front of a light source or a reflective surface. In addition to the low power consumption, the LCDs also characterized by attributes including high display performance, small dimension, and light weight, and thus have become the main stream of the display devices. Currently, thin film transistor (TFT) LCD is the most popular one.

With the increasing dimension of TFT-LCD, the viewing angle also increases, which results in the decreasing contrast and resolution. This is mainly due to the changed birefringence index of the liquid crystal molecules. It is known that the brightness may greatly decreased when the viewing angle equals to a specific value. The viewing angle for traditional LCD usually equals to 90 degrees, that is, 45 degrees for both the right side and the left side. The linear liquid crystal for manufacturing the liquid crystal panel is the material with birefringence index Δn. When passing through the liquid crystal molecules, the light beams may be divided into ordinary rays and extraordinary rays. If the light beams oblique incidents on the liquid crystal molecules, two reflective light beams are generated. The birefringence index Δn=ne−no, where “ne” represents the reflective index of the liquid crystal molecules relating to ordinary light beams and “no” represents the reflective index of the liquid crystal molecules relating to non-ordinary light beams. Thus, when the light beams pass through the liquid crystal molecules between the two glasses, phase retardation occurs. The optical characteristics of the liquid crystal cell is usually evaluated by the phase retardation, i.e., Δn×d, which is usually called as the optical path difference, where Δn represents the birefringence index and d represents the thickness of the liquid crystal cell. The above mentioned problem is caused by the different phase retardation in different viewing angles. The phase retardation of good optical compensation film may offset that of the linear liquid crystal molecules so as to increase the visible angle of the liquid crystal panel.

The compensation principle of the optical compensation film relates to alter the phase difference resulting from different viewing angles. In this way, the birefringence liquid crystal molecules can be compensated symmetrically. By adopting the optical compensation film, the dark-state light leakage may be greatly reduced, and the contrast can also be greatly enhanced within a certain viewing angle. The optical compensation film includes retardation films, compensation films, wide view films, and so on. The optical compensation film can reduce the light leakage amount in the dark-state. In addition, the contrast and color saturation can be greatly enhanced, and some inversed gray scale issue can be overcome. The parameters for evaluating the optical compensation film includes an in-plane delay Ro, a thickness direction delay Rth, a refractive rate N, and a film thickness D. The following equations are satisfied:

Ro=(Nx−Ny)×D;

Rth=[(Nx+Ny)/2−Nz]×D;

Wherein, Nx is a refractive index along the slow axis in the plane of the film (having a maximum refractive index axis, i.e., light having a slower velocity of propagation of the vibration direction), Ny is a refractive index along a fast axis in the plane of the film (having a minimum refractive index axis, that is, light having a vibration direction of the fast propagation rate, perpendicular to Nx), and Nz is a refractive index in the plane of the film (perpendicular to Nx and Ny).

Different optical compensation films are adopted for different display modes, i.e., liquid crystal cells. Also, the values of Ro and Rth have to be configured accordingly. Currently, the optical compensation films adopted by the large-scale LCDs focus on the vertical alignment (VA) display mode. In the past, the optical compensation films, including N-TAC developed by Konica, Zeonor developed by OPTES, F-TAC developed by Fujitsu, and X-plate developed by Nitto Denko are adopted in sequence.

It is known that different optical compensation modes have to configured in accordance with different optical path difference. FIG. 1 is a diagram depicting the dark-state brightness distribution at all viewing angles of one conventional compensation structure after being compensated. FIG. 2 is a diagram depicting the dark-state contrast distribution at all viewing angles of the liquid crystal panel of FIG. 1. The optical path difference of the liquid crystal panel of FIGS. 1 and 2 is within a range between 324.3 and 342.7. It can be seen from FIGS. 1 and 2 that the light leakage is serious for the locations at phi=20-40°, phi=140-160°, phi=200-220° and phi=310-330°. In addition, the contrast and the resolution at the above locations are quite low. As the relative locations of audiences and TV determines the viewable area in the horizontal viewing angle, and the deteriorated contrast and the resolution may greatly affect the display performance.

### SUMMARY

To overcome the above problem, the compensation structure for the liquid crystal panels is capable of greatly reducing the dark-state light leakage by configuring the retardation values for the liquid crystal panel having the optical path difference within a range between 323.3 and 342.7 nm. In addition, the contrast and the resolution in wide viewing angle can be enhanced.

In one aspect, a compensation structure of liquid crystal panels includes:

a liquid crystal panel and a first polarizing film and a second polarizing film arranged on two opposite surfaces of the liquid crystal panel, the liquid crystal panel includes a liquid crystal layer having a plurality of liquid crystal molecules, an anisotropy reflective index of the liquid crystal layer is Δn, the thickness of the liquid crystal layer is d, a pretilt angle of the liquid crystal molecules is θ, the first compensation film is a biaxial compensation film, an in-plane retardation value and a thickness retardation value of the first compensation film are respectively Ro1 and Rth1, the second compensation film is the single-axial compensation film, and the thickness retardation value of the second compensation film is Rth2, wherein: 324.3 nm≦Δn×d≦342.7 nm; 85°≦θ<90°; 55 nm≦Ro1≦78 nm; 208 nm≦Rth1≦293 nm; Y1 nm≦Rth2≦Y2 nm; Y1=0.001897×(Rth1)² —2.01×Rth1+438.7; Y2=−0.005756×(Rth1)²+1.654×Rth1+55.7.

Wherein 58 nm≦Ro1≦71 nm, and 220 nm≦Rth1≦269 nm.

Wherein 44 nm≦Rth2≦139 nm.

Wherein a first polarizing film and a first protection film are arranged on the first compensation film in turn, and a second polarizing film and a second protection film are arranged on the second compensation film in turn.

Wherein the first polarizing film and the second polarizing film are made by Polyvinyl alcohol (PVA).

Wherein the first protection film and the second protection film are made by Triacetyl Cellulose (TAC).

Wherein an included angle between a light absorbing axis of the first polarizing film and a slow axis of the first compensation film is 90 degrees, and the included angle between the light absorbing axis of the second polarizing film and the slow axis of the second biaxial compensation film is 90 degrees.

Wherein a first adhesive layer is arranged between the liquid crystal panel and the first compensation film, and a second adhesive layer is arranged between the liquid crystal panel and the second compensation film, and the first adhesive layer and the second adhesive layer are made by pressure sensitive adhesive (PSA).

Wherein the liquid crystal panel is a vertical alignment mode.

In another aspect, a liquid crystal device includes: a liquid crystal panel and a backlight module arranged opposite to the liquid crystal display panel, the backlight module provides a light source to the liquid crystal display panel such that the liquid crystal display panel is capable of displaying images, the liquid crystal panel includes the above compensation structure.

In view of the above, the compensation structure for the liquid crystal panel is capable of greatly reducing the dark-state light leakage by configuring the retardation values for the liquid crystal panel having the optical path difference within a range between 323.3 and 342.7 nm. In addition, the contrast and the resolution in wide viewing angle can be enhanced.

### BRIEF DESCRIPTION OF THE DRAWINGS

FIG. 1 is a diagram depicting the dark-state brightness distribution at all viewing angles of one conventional liquid crystal panel.

FIG. 2 is a diagram depicting the dark-state contrast distribution at all viewing angles of the liquid crystal panel of FIG. 1.

FIG. 3 is a schematic view showing the liquid crystal device in accordance with one embodiment.

FIG. 4 is a schematic view showing the liquid crystal panel in accordance with one embodiment.

FIG. 5 is a trend diagram showing the relationship between the dark-state light leakage and the retardation values when the optical path difference is 324.3 nm in accordance with one embodiment.

FIG. 6 is a trend diagram showing the relationship between the dark-state light leakage and the retardation values where the optical path difference is 333.6 nm in accordance with one embodiment.

FIG. 7 is a trend diagram showing the relationship between the dark-state light leakage and the retardation values where the optical path difference is 342.7 nm in accordance with one embodiment.

FIG. 8 is a diagram depicting the dark-state brightness distribution at all viewing angles of the liquid crystal panel after being compensated in accordance with one embodiment.

FIG. 9 is a diagram depicting the dark-state contrast distribution at all viewing angles of the liquid crystal panel of FIG. 8.

FIG. 10 is a diagram depicting the dark-state brightness distribution at all viewing angles of the liquid crystal panel after being compensated in accordance with another embodiment.

FIG. 11 is a diagram depicting the dark-state contrast distribution at all viewing angles of the liquid crystal panel of FIG. 10.

FIG. 12 is a diagram depicting the dark-state brightness distribution at all viewing angles of the liquid crystal panel after being compensated in accordance with another embodiment.

FIG. 13 is a diagram depicting the dark-state contrast distribution at all viewing angles of the liquid crystal panel of FIG. 12.

### DETAILED DESCRIPTION OF THE EMBODIMENTS

Embodiments of the invention will now be described more fully hereinafter with reference to the accompanying drawings, in which embodiments of the invention are shown.

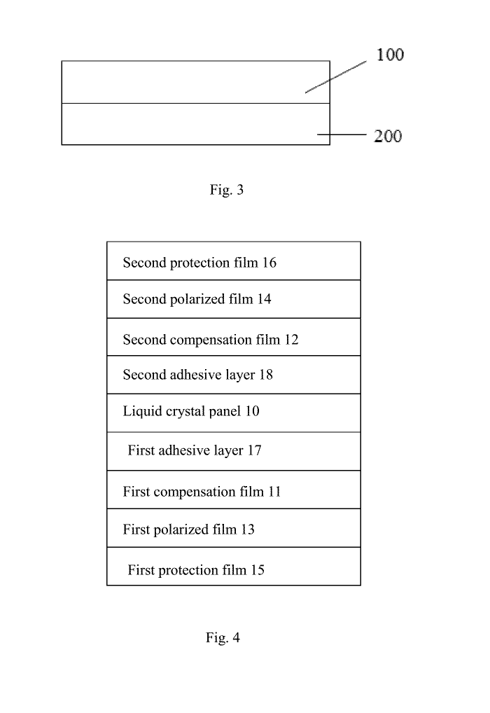

Referring to FIG. 3, the LCD includes a liquid crystal display panel 100 and a backlight module 200 arranged opposite to the liquid crystal display panel 100. The backlight module 200 provides a light source to the liquid crystal display panel 100 such that the liquid crystal display panel 100 can display images. The liquid crystal display panel 100 is the liquid crystal panel adopting a compensation structure.

FIG. 4 is a schematic view showing the compensation structure in accordance with one embodiment. The compensation structure includes a liquid crystal panel 10 and a first compensation film 11 and a second compensation film 12. A first polarized film 13 and a first protection film 15 are arranged on the first compensation film 11 in turn. A second polarized film 14 and a second protection film 16 are arranged on a second compensation film 12 in turn. A first adhesive layer 17 is arranged between the liquid crystal panel 10 and the first compensation film 11. A second adhesive layer 18 is arranged between the liquid crystal panel 10 and the second compensation film 12. The liquid crystal panel 10 is a VA liquid crystal cell (VA cell). The first polarizing film 13 and the second polarizing film 14 are made by Polyvinyl alcohol (PVA). An included angle between a light absorbing axis of the first polarizing film 13 and a slow axis of the first compensation film 11 is configured to be 90 degrees. The included angle between the light absorbing axis of the second polarizing film 14 and the slow axis of the second compensation film 12 is configured to be 90 degrees. In the embodiment, the first protection film 15 and the second protection film 16 are made by Triacetyl Cellulose (TAC). The first protection film 15 and the second protection film 16 are mainly for protecting the first PVA polarizing film 13 and the second PVA polarizing film 14 so as to enhance the mechanical functions of the first PVA polarizing film 13 and the second PVA polarizing film 14 and to prevent the first PVA polarizing film 13 and the second PVA polarizing film 14 from retraction. The first adhesive layer 17 and the second adhesive layer 18 are made by pressure sensitive adhesive (PSA). The liquid crystal panel 10 includes a liquid crystal layer having a plurality of liquid crystal molecules. The anisotropy reflective index of the liquid crystal layer is Δn, the thickness of the liquid crystal layer is d, and the pretilt angle of the liquid crystal molecules is θ. In the above example, the in-plane retardation value of the first compensation film 11 is Ro1, and the thickness retardation is Rth1, the in-plane retardation value of the second compensation film 12 is Ro2, and the thickness retardation value of the first protection film 14 is Rth2.

The above structure mainly focuses on the liquid crystal panel with low optical path difference within a range between 324.3 and 342.7. By configuring appropriate retardation values for the first compensation film 11 and second compensation film 12, the dark-state light leakage can be greatly reduced. Thus, the contrast and the resolution in wide viewing angle can be increased.

The following configurations are adopted in related simulations.

The liquid crystal layer is configured as below.

1. The pretile angle θ: 85°≦θ<90°;

2. The pretile angles for four dimensions are respectively 45, 135, 225, 315 degrees; and

3. The optical path difference Δn×d: 342.8 nm≦Δn×d≦361.4 nm.

The backlight source is configured as below:

1. Light source: Blue-YAG LED optical spectrum;

2. The central brightness of the light source is 100 nit; and

3. The light source distribution is Lambert's distribution.

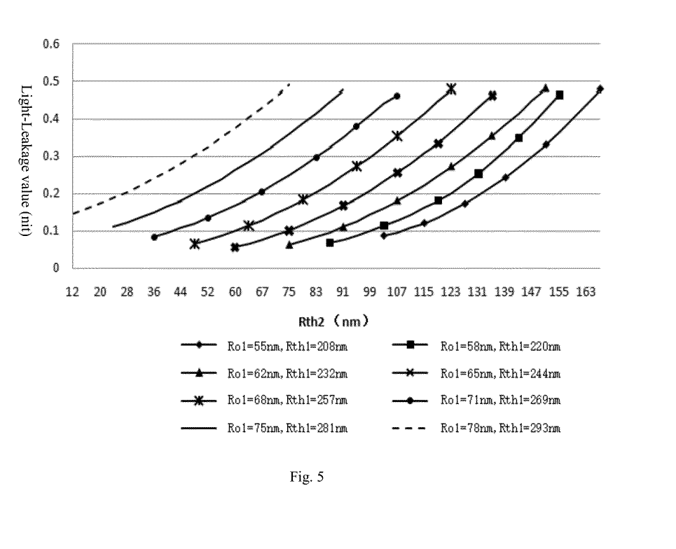

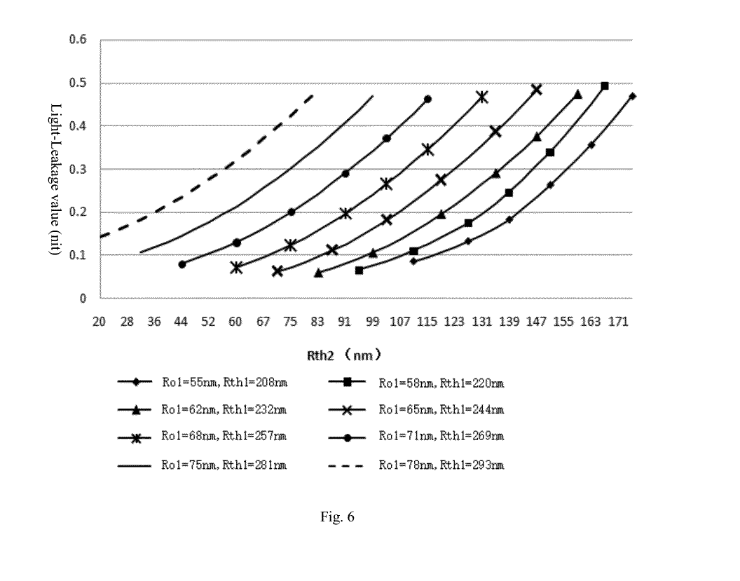

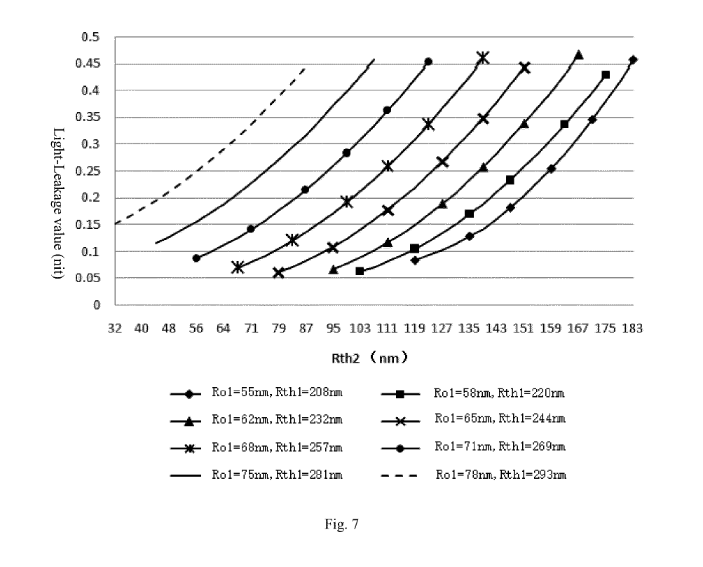

FIG. 5 is a trend diagram showing the relationship between the dark-state light leakage and the retardation values for the conditions including the optical path difference is 324.3 nm and the pretile angle is 89 degrees. FIG. 6 is a trend diagram showing the relationship between the dark-state light leakage and the retardation values where the optical path difference is 333.6 nm and the pretile angle is 89 degrees. FIG. 7 is a trend diagram showing the relationship between the dark-state light leakage and the retardation values where the optical path difference is 342.7 nm in accordance with one embodiment. The simulations are conducted by combinations of different pretile angles and retardation values, and the conditions include: 324.3 nm≦Δn×d≦342.7 nm; 85°≦θ<90°; and the dark-state light leakage is smaller than 0.2 nit. The corresponding ranges of the retardation values for the first compensation film 11 and second compensation film 12 are: 55 nm≦Ro1≦78 nm; 208 nm≦Rth1≦293 nm; Y1 nm≦Rth2≦Y2 nm; wherein

Y1=0.001897×(Rth1)²−2.01×Rth1+438.7;

Y2=−0.005756×(Rth1)²+1.654×Rth1+55.7

The retardation values of the compensation film, including Ro, Rth, the reflective index N and the thickness D, satisfy the equations below:

Ro=(Nx−Ny)×D;

Rth=[(Nx+Ny)/2−Nz]×D;

For single axis compensation film, Nx=Ny and Ro=0.

Thus, the retardation values may be changed by three methods.

1. The thickness D is changed while the reflective index N of the biaxial compensation film remains the same.

2. The reflective index N is changed while the thickness D of the biaxial compensation film remains the same.

3. The thickness D and the reflective index N are changed at the same time, but the ranges of the retardation values of the biaxial compensation film are guaranteed.

Some of the retardation values are selected to test the compensation result so as to further describe the technical effects of the present disclosure.

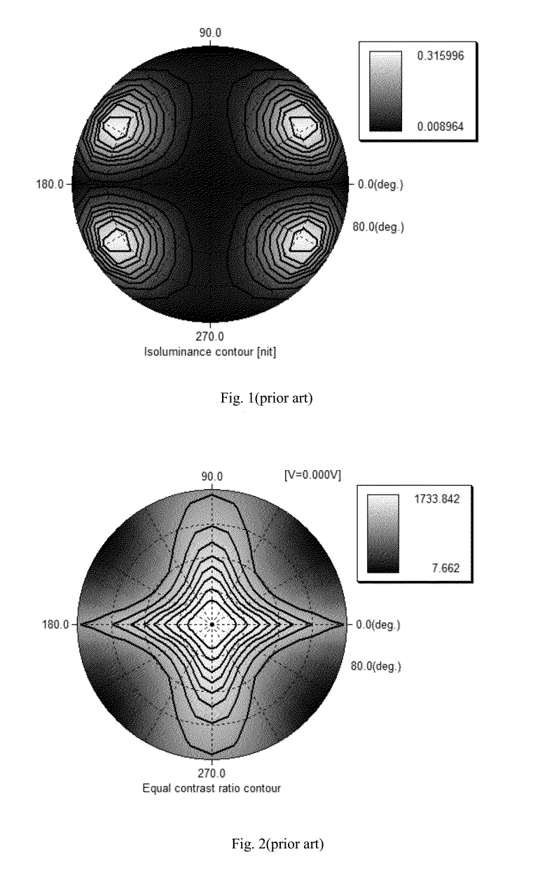

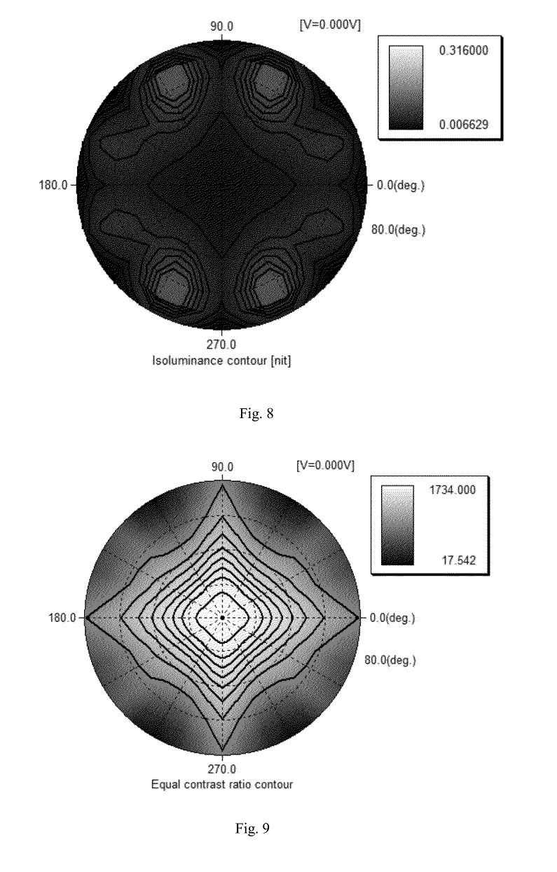

FIG. 8 is a diagram depicting the dark-state brightness distribution at all viewing angles of the compensation structure after being compensated in accordance with one embodiment. FIG. 9 is a diagram depicting the dark-state contrast distribution at all viewing angles of the liquid crystal panel of FIG. 8. The conditions set for FIGS. 8 and 9 include: the optical path difference Δn×d=324.3 nm, the pretilt angle θ=89°, Ro1=71 nm, Rth1=269 nm, and Rth2=44 nm. The measured maximum dark-state light leakage is 0.2 nit. Comparing FIG. 8 with FIG. 1, it can be seen that the dark-state light leakage of the compensation structure of FIG. 8 is much lower than that of FIG. 1. Comparing FIG. 9 with FIG. 2, it can be seen that the contrast distribution for all viewing angles of FIG. 9 is better than that of FIG. 2.

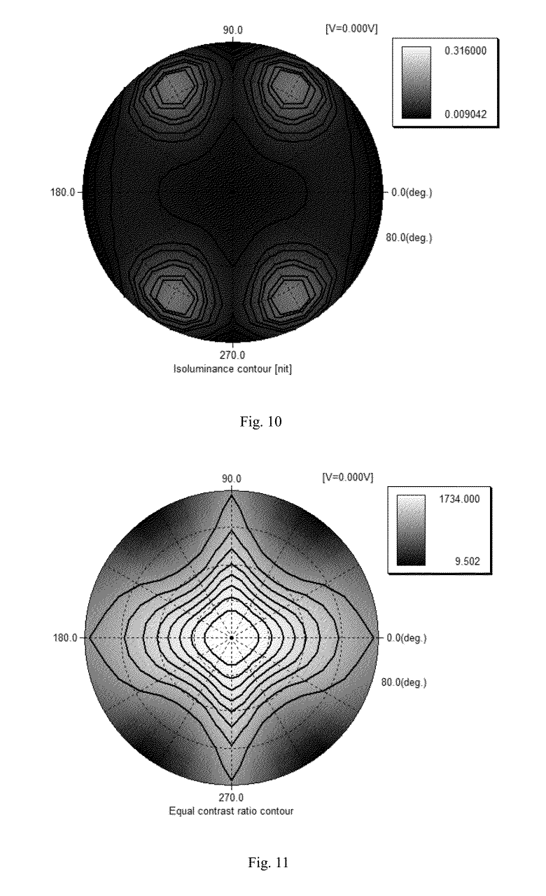

FIG. 10 is a diagram depicting the dark-state brightness distribution at all viewing angles of the compensation structure after being compensated in accordance with another embodiment. FIG. 11 is a diagram depicting the dark-state contrast distribution at all viewing angles of the liquid crystal panel of FIG. 10. The conditions set for FIGS. 10 and 11 include: optical path difference Δn×d=333.6 nm, pretilt angle θ=89°, Ro1=65 nm, Rth1=244 nm, and Rth2=95 nm. Comparing FIG. 10 with FIG. 1, it can be seen that the dark-state light leakage of the compensation structure of FIG. 10 is much lower than that of FIG. 1. Comparing FIG. 11 with FIG. 2, it can be seen that the contrast distribution for all viewing angles of FIG. 11 is better than that of FIG. 2.

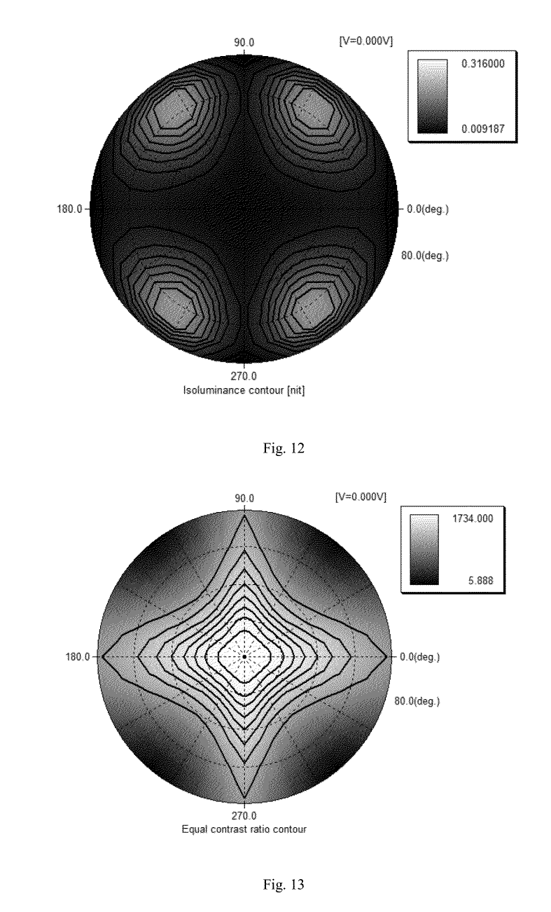

FIG. 12 is a diagram depicting the dark-state brightness distribution at all viewing angles of the compensation structure after being compensated in accordance with another embodiment. FIG. 13 is a diagram depicting the dark-state contrast distribution at all viewing angles of the liquid crystal panel of FIG. 12. The conditions set for FIGS. 12 and 13 include: the optical path difference Δn×d=342.7 nm, the pretilt angle θ=89°, Ro1=58 nm, Rth1=220 nm, and Rth2=139 nm. The measured maximum dark-state light leakage is 0.19 nit. Comparing FIG. 12 with FIG. 1, it can be seen that the dark-state light leakage of the compensation structure of FIG. 12 is much lower than that of FIG. 1. Comparing FIG. 13 with FIG. 2, it can be seen that the contrast distribution for all viewing angles of FIG. 13 is better than that of FIG. 2.

The values of the above parameters, including optical path difference Δn×d, pretilt angle θ and Ro1, Rth1, Ro2 and Rth2 are only taken as examples for some embodiments. The parameters are selected within the following ranges: 55 nm≦Ro1≦78 nm; 208 nm≦Rth1≦293 nm; Y1 nm≦Rth2≦Y2 nm; Y1=0.001897×(Rth1)²−2.01×Rth1+438.7; Y2=−0.005756×(Rth1)²+1.654×Rth1+55.7.

In view of the above, the double-layered biaxial compensation structure for the liquid crystal panel is capable of greatly reducing the dark-state light leakage by configuring the retardation values for the liquid crystal panel. In addition, the contrast and the resolution in wide viewing angle can be enhanced.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A compensation structure of liquid crystal panels, comprising:
a liquid crystal panel and a first polarizing film and a second polarizing film arranged on two opposite surfaces of the liquid crystal panel, the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, the first compensation film is a biaxial compensation film, an in-plane retardation value and a thickness retardation value of the first compensation film are respectively Ro1 and Rth1, the second compensation film is the single-axial compensation film, and the thickness retardation value of the second compensation film is Rth2, wherein:
324.3 nm≦Δn×d≦342.7 nm;
85°≦θ<90°;
55 nm≦Ro1≦78 nm;
208 nm≦Rth1≦293 nm;
Y1 nm≦Rth2≦Y2 nm;
Y1=0.001897×(Rth1)²−2.01×Rth1+438.7;
Y2=−0.005756×(Rth1)²+1.654×Rth1+55.7.

2. The compensation structure as claimed in claim 1, wherein 58 nm≦Ro1≦71 nm, and 220 nm≦Rth1≦269 nm.

3. The compensation structure as claimed in claim 2, wherein 44 nm≦Rth2≦139 nm.

4. The compensation structure as claimed in claim 1, wherein a first polarizing film and a first protection film are arranged on the first compensation film in turn, and a second polarizing film and a second protection film are arranged on the second compensation film in turn.

5. The compensation structure as claimed in claim 4, wherein the first polarizing film and the second polarizing film are made by Polyvinyl alcohol (PVA).

6. The compensation structure as claimed in claim 4, wherein the first protection film and the second protection film are made by Triacetyl Cellulose (TAC).

7. The compensation structure as claimed in claim 4, wherein an included angle between a light absorbing axis of the first polarizing film and a slow axis of the first compensation film is 90 degrees, and the included angle between the light absorbing axis of the second polarizing film and the slow axis of the second biaxial compensation film is 90 degrees.

8. The compensation structure as claimed in claim 1, wherein a first adhesive layer is arranged between the liquid crystal panel and the first compensation film, and a second adhesive layer is arranged between the liquid crystal panel and the second compensation film, and the first adhesive layer and the second adhesive layer are made by pressure sensitive adhesive (PSA).

9. The compensation structure as claimed in claim 1, wherein the liquid crystal panel is a vertical alignment mode.

10. A liquid crystal device, comprising:
a liquid crystal panel and a backlight module arranged opposite to the liquid crystal display panel, the backlight module provides a light source to the liquid crystal display panel such that the liquid crystal display panel is capable of displaying images, the liquid crystal panel comprises a compensation structure, and the compensation structure comprises:
a first polarizing film and a second polarizing film arranged on two opposite surfaces of the liquid crystal panel, the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, the first compensation film is a biaxial compensation film, an in-plane retardation value and a thickness retardation value of the first compensation film are respectively Ro1 and Rth1, the second compensation film is the single-axial compensation film, and the thickness retardation value of the second compensation film is Rth2, wherein:
324.3 nm≦Δn×d≦342.7 nm;
85°≦θ<90°;
55 nm≦Ro1≦78 nm;
208 nm≦Rth1≦293 nm;
Y1 nm≦Rth2≦Y2 nm;
Y1=0.001897×(Rth1)²−2.01×Rth1+438.7;
Y2=−0.005756×(Rth1)²+1.654×Rth1+55.7.

11. The liquid crystal device as claimed in claim 10, wherein 58 nm≦Ro1≦71 nm, and 220 nm≦Rth1≦269 nm.

12. The liquid crystal device as claimed in claim 11, wherein 44 nm≦Rth2≦139 nm.

13. The liquid crystal device as claimed in claim 10, wherein Ro1=Ro2 and Rth1=Rth2.

14. The liquid crystal device as claimed in claim 13, wherein the first polarizing film and the second polarizing film are made by Polyvinyl alcohol (PVA).

15. The liquid crystal device as claimed in claim 13, wherein the first protection film and the second protection film are made by Triacetyl Cellulose (TAC).

16. The liquid crystal device as claimed in claim 13, wherein an included angle between a light absorbing axis of the first polarizing film and a slow axis of the first compensation film is 90 degrees, and the included angle between the light absorbing axis of the second polarizing film and the slow axis of the second biaxial compensation film is 90 degrees.

17. The liquid crystal device as claimed in claim 10, wherein a first adhesive layer is arranged between the liquid crystal panel and the first compensation film, and a second adhesive layer is arranged between the liquid crystal panel and the second compensation film, and the first adhesive layer and the second adhesive layer are made by pressure sensitive adhesive (PSA).

18. The liquid crystal device as claimed in claim 10, wherein the liquid crystal panel is a vertical alignment mode.
